(19) United States
(12) Patent Application Publication
(10) Pub. No.: US 2010/0072712 A1
(43) Pub. Date: Mar. 25, 2010

(54) Pressure packing comprised of packing rings secured against rotation with injection-molded segments

(75) Inventor: Christian Hold, Wien (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: HOERBIGER KOMPRESSORTECHNIK HOLDING GMBH

(21) Appl. No.: 12/585,461

(22) Filed: Sep. 15, 2009

(30) Foreign Application Priority Data
Sep. 25, 2008 (AT) A 1497/2008

(51) Int. Cl. F16J 15/18

(52) U.S. Cl. 277/511

(57) ABSTRACT

Conventional anti-rotation devices comprised of packing rings in a packing container of a pressure packing consist of an anti-rotation pin inserted in a packing ring and engaging in a recess at an adjacent packing ring. Due to the different wear rates of the packing rings such anti-rotation pins are subject to shear stress that increases with wear and that can cause the anti-rotation pin to break. Injection-molded packing ring segments with molded anti-rotation nibs in turn require great material thickness for the anti-rotation nibs to be able to withstand the occurring stresses. To solve this problem, the invention suggests to mold a radial anti-rotation groove 24 at a radially cut packing ring segment 21 at one end, and to mold an anti-rotation nib 26 at an injection-molded tangentially cut packing ring segment 20, said anti-rotation nib engaging in the radial anti-rotation groove 24.

The invention relates to a pressure packing with a radially cut and a tangentially cut packing ring, each composed of a number of packing ring segments, and with said radially cut and said tangentially cut packing ring arranged abutting one another at the front surface, as well as such an injection-molded radially and tangentially cut packing ring segment.

Packing rings of pressure packings for sealing piston rods in compressors generally consist of radially or tangentially cut packing ring segments that are loosely assembled into a packing ring and held together by means of a circumferential spring. In a packing container several packing rings are arranged side by side, e.g. a radially cut packing ring alongside a tangentially cut packing ring, and in a pressure packing several packing containers may be arranged in series. As is known, the packing rings arranged side by side do not only need to seal in the direction of the piston rod, but also in axial direction, to prevent the sealing medium from passing through the gaps and joints at the packing rings without obstruction. To this end, the packing rings are arranged such that the gap or the joints are mutually overlapped by the adjacent packing rings. To maintain this relative position to each other during operation, an anti-rotation pin is provided that engages in recesses in both packing rings, thus preventing the packing rings from rotating relative to one another. Packing rings in a package, however, may wear at different rates, increasingly subjecting an anti-rotation pin to shear stress with increasing wear. This stress may become great enough to cause the anti-rotation pin to break off or break out of the segment. Besides the apparent problem that a broken anti-rotation pin could damage the packing container or the pressure packings or even the piston rod, the pressure packing's sealing effect could also be lost, if the packing rings align themselves relative to one another such that the overlap of the gaps or joints disappears. Especially, at occurrence of the so called “oil hammer”, which results in the abrupt opening of the radially and tangentially cut ring, it frequently happens that the anti-rotation pin breaks off or breaks out due to the abrupt relative movement between the two rings. An anti-rotation pin inserted inside a packing ring and run inside a groove in the adjacent packing ring may solve this problem, so that the packing rings may wear differently without subjecting the anti-rotation pin to stress. Such a pressure packing may for example be inferred from US 2004/0227301 A1.

Packing rings are produced from a tribologically beneficial and wear-resistant material, such as for example PTFE. Packing ring segments are manufactured—frequently costly—by means of a machining production method, preferentially a turning or milling method, from a semi-finished product. In terms of the mechanical and the physical properties of the packing ring segment, as well as in terms of the production expenditure, manufacturing the packing ring segments by means of the injection molding method, as is for example known from WO 98/04853 A, is less costly from the perspective of the manufacturing process. However, the materials used for the packing rings do not consist of construction materials due to their low mechanical snibility. Thus, an anti-rotation pin molded to a packing ring by means of the injection molding process would need to have great material thickness in order to be able to withstand operational stresses. Hence, the anti-rotation pin would have to feature a corresponding width and length, which would require an equally wide and long recess at the adjoining packing ring. However, especially the design of the groove's length is limited by the height of the packing ring segment and by the fact that the recess for accommodating the pin must not exceed the total height of the packing ring segment for functional reasons. However, such a large recess inside a packing ring segment—even at all feasible from a design perspective—would also mean a significant mechanical weakening of the packing ring segment. To counterbalance this, the design of the packing ring segment would have to be stronger (e.g. thicker), which however would not be desirable for reasons of cost and space. For these reasons manufacturing and utilizing injection-molded packing ring segments with molded anti-rotation pins or molded recesses was previously not taken into account despite the associated advantages.

The aim of the present invention is to specify a radially cut and corresponding tangentially cut packing ring with injection-molded packing ring segments and an anti-rotation device, as well as a packing container comprised of such packing rings, and a pressure packing with such a packing container, that solve the problems of a conventional anti-rotation device with anti-rotation pins, as well as the problems with molded anti-rotation pins and grooves in terms of production technique.

For the radially cut injection-molded packing ring segment this task is solved in that a radial anti-rotation groove is molded inside a front surface at one end of the packing ring segment. For the tangentially cut injection-molded packing ring segment this task is solved in that an anti-rotation nib is molded at the tangentially cut packing ring segment that protrudes from one front surface of the packing ring segment. The task for the packing container is solved in that a radial anti-rotation groove is molded at a radially cut packing ring segment at one end of the packing ring segment at a front surface facing the tangentially cut packing ring, and in that an anti-rotation nib is molded at an injection-molded tangentially cut packing ring segment at a front surface facing the radially cut packing ring, said anti-rotation nib engaging in the radial anti-rotation groove. The arrangement of the anti-rotation groove at the end of the radially cut packing ring segment—viewed in circumferential direction—exploits the fact that a wear gap exists between two adjacent radially cut packing ring segments anyway. This makes it possible to design the anti-rotation groove narrower equivalent to the width of the wear gap plus an allowable wear measurement of the radially cut packing ring. As a result, the local mechanics of the radially cut packing ring segment is weakened less by the anti-rotation groove. The anti-rotation nib is formed by injection molding technology, thus considerably simplifying the production of such a packing ring segment. Moreover, no conventional anti-rotation pin must be mounted in the packing ring any longer, which would also constitute a mechanical weakening of the segment. Given the fact that not only the width of the anti-rotation groove, but also the width of the wear gap of the radially cut packing ring is available to accommodate the anti-rotation nib, the anti-rotation nib may be designed broader and thus stronger. Since the anti-rotation nib consists of the same material as the packing ring, said nib may also be designed longer in radial direction, since the anti-rotation nib would simply also wear without any harm to the packing ring during the gradual wear of the packing ring segments. By channeling the anti-rotation nib inside an anti-rotation groove a sizable radial relative movement between the radially and tangentially cut packing ring is possible without subjecting the anti-rotation nib to mechanical stresses. Thus, the anti-rotation device according to the invention can also not be affected by abrupt relative movements between the two packing rings, e.g. when oil penetrates the combustion chamber.

Advantageously, a radial anti-rotation groove is molded inside a front surface at both ends of the radially cut packing ring segment. In a packing container, preferably at the facing ends of two adjacent radially cut packing ring segments, a radial anti-rotation groove is molded, with the anti-rotation nib engaging in the anti-rotation grooves of the two radially cut packing ring segments. This way, the width of the groove can become even narrower or rather the anti-rotation nib may become wider, since the anti-rotation nib can engage in both adjacent grooves.

If the anti-rotation groove is molded up to the radially outer circumferential surface and/or up to the radially inner circumferential surface of the packing ring segment, the anti-rotation nib may become even longer in radial direction, thereby also increasing the possible material thickness of the anti-rotation nib.

Advantageously, the anti-rotation nib extends over a portion of the radial height, advantageously also over the entire height of the packing ring segment, thereby utilizing the radial height of the packing ring segment as best as possible for the anti-rotation nib.

Preferably, an anti-rotation groove or an anti-rotation nib is provided at all radially or tangentially cut packing ring segments, with only one type of packing ring segment available in each case, thus simplifying production.

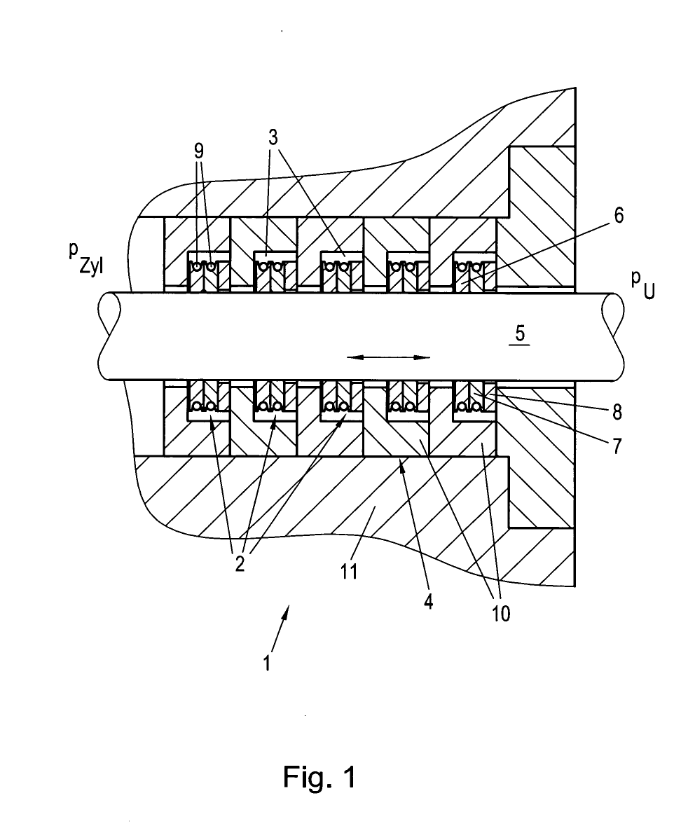

The invention is described below based on the FIGS. 1 through 5 showing schematic, exemplary, non-limiting and advantageous embodiments. In this connection,

FIG. 1 shows a pressure packing with several packing containers,

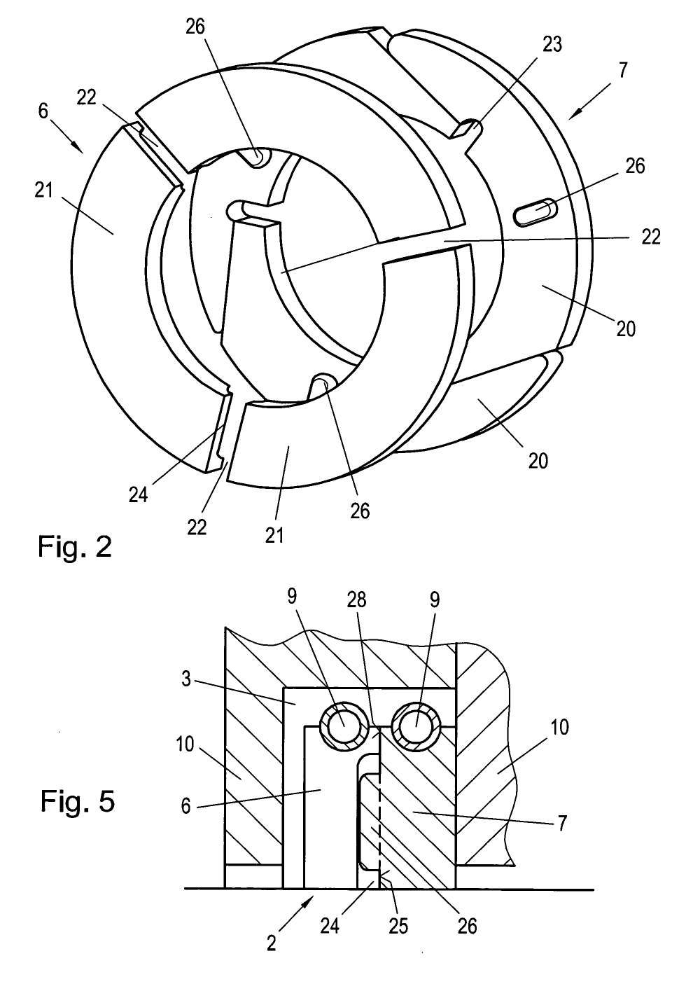

FIG. 2 shows an arrangement comprising a radially and tangentially cut packing ring with an anti-rotation device according to the invention,

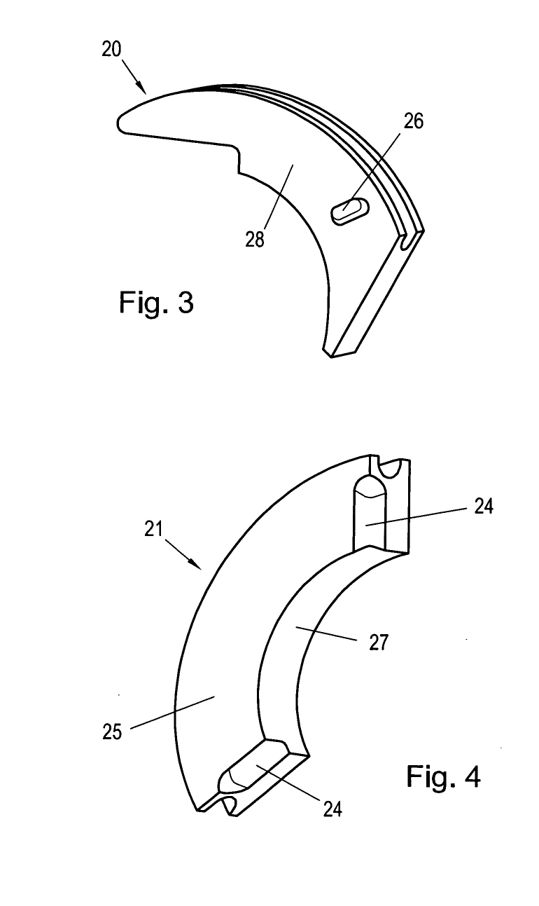

FIG. 3 shows a tangentially cut packing ring segment according to the invention,

FIG. 4 shows a radially cut packing ring segment according to the invention, and

FIG. 5 shows an arrangement comprising a radially and tangentially cut packing ring segment with an anti-rotation device according to the invention in a packing container.

As is known, piston compressors 1, above all of the double-acting design, require sealing of the crank-side compression space inside the cylinder, in which the time-variable (high) cylinder pressure p_{zyl}, prevails, along the oscillating piston rod 5 against the (low) ambient pressure pᵤ prevailing in the crankcase. Such sealing is usually accomplished by means of the so-called seal package 4, as shown in a simplified manner in FIG. 1. The sealing elements used in such a pressure packing 4 are referred to as packing rings 6, 7, and are arranged in so-called packing containers 2, typically consisting of a number of packing rings 6, 7. In order to increase the service life and the reliability of a pressure packing 4 several such packing rings 6, 7 are arranged in series. In one pressure packing 4 several packing containers 2 are typically lined up one after another. The relative movement of the contact surfaces between the piston rod 5 and the rings 6, 7 causes wear of the packing rings 6, 7. Usually, this ring wear requires cut ring shapes allowing automatic continuous adjustment of the ring in the event of material removal from this sealing gap ring/piston rod. Radially and tangentially cut rings 6, 7, used in pairs in packing chambers 3 of the packing containers 2 in order to mutually cover the occurring impact gaps to compensate for wear, are standard in the industry in this connection. As is known, hose springs (circumferential springs) wound over the outer circumference are typically used in connection with cut ring shapes, which press the packing rings 6, 7 against the piston rod 5, even in the pressureless state. In conventional arrangements a significant extrusion of the packing rings 6, 7 can also occur in the gap formed between the piston rod 5 and the packing container 2, or the chamber ring 10—in particular at higher pressures. To avoid said extrusion as best as possible, additional metallic support rings 8 that do not touch the piston rod 5 in a planar manner may be used between the ring on the low-pressure side and the chamber ring 10.

When combining a radially and a tangentially cut packing ring 6, 7, sealing toward the piston rod 5 is essentially accomplished only by the tangentially cut packing ring 7, the ring segments 20 of which can slide together as a result of the tangential cut guidance in the event of wear, and thus maintain the sealing effect. Essentially, the only purpose of the radially cut packing ring 6 is to seal the wear gap 23 and the tangential joint of the tangential packing ring 7 in axial and radial direction. The radially cut packing ring 6 wears to a lesser degree during its entire service life due to the differently acting pressure difference. A radial wear gap 22 forms between the radial packing ring segments 21. Thus, at most, the radial packing ring 6 can wear only until the packing ring segments 21 abut one another in circumferential direction. Thus, the radially and tangentially cut packing rings 6, 7 wear differently due to the differently acting pressure differences.

For the wear gap 22, 23 and the joint to be sealed by the respectively other ring, which is essential for the sealing effect, the radially and tangentially cut packing ring 6, 7 must not, or only slightly, rotate relative to each other. Hence, an anti-rotation device intended to prevent such rotation is necessary and will be described below with reference to the FIGS. 2 through 5.

According to the invention, the radially and tangentially cut packing ring segments 20, 21 are manufactured by means of the injection-molding method. At least one radially cut packing ring segment 21 an anti-rotation groove 24 is molded at one end (viewed in circumferential direction) inside a front surface 25 (see FIG. 4). Said anti-rotation groove 24 is open in circumferential direction toward the end of the segment, and is preferably radially oriented, and may extend from the inner circumferential surface 27 for a certain length in radial direction. The anti-rotation groove 24 could also extend over the entire radial height of the packing ring segment 21. However, said anti-rotation groove 24 may also only be arranged in a central manner, whereby a short bar would form radially inside and outside. At both ends of the radial packing ring segment 21 such an anti-rotation groove 24 can also be provided. In this connection, advantageously the anti-rotation groove 24 may already be molded during injection molding through appropriate shaping of the injection mold, but may also be incorporated after the injection molding, e.g. through milling.

At a tangentially cut packing ring segment 20 an anti-rotation nib 26 is molded by means of the injection molding method, said anti-rotation nib 26 protruding from a front surface 28 (see FIG. 3). Preferably, said anti-rotation nib 26 is aligned in a radial manner and extends over a portion of the radial height of the packing ring segment 20. Said anti-rotation nib 26 could also reach up to the radially inner circumferential surface of the tangential packing ring segment 20, or extend over the entire radial height of the packing ring segment 20. Since the anti-rotation nib 26 consists of the same material as the packing ring segment 20 as a result of the injection molding, the anti-rotation nib 26 simply wears along with the gradual wear of the tangential packing ring segment 20. For this reason, the anti-rotation nib 26 can also become sufficiently long to achieve the material thickness necessary to withstand the mechanical stresses affecting it.

A number of tangentially cut packing ring segments 20 are assembled into a tangentially cut packing ring 7, which—in a packing container 2 at the front surface—abuts a radially cut packing ring 6, the latter being comprised of a number of radially cut packing ring segments 21, as illustrated in FIG. 5. In this process, the anti-rotation nib 26 engages in the anti-rotation groove 24, thus preventing the packing rings 6, 7 from rotating relative to one another, or allowing rotation only to a certain degree, determined by the width of the anti-rotation groove 24 in relation to the width of the anti-rotation nib 26. The anti-rotation nib 26 can also engage in the anti-rotation grooves 24 of two adjacent radially cut packing ring segments 21. Due to the arrangement of the anti-rotation groove 24 at the end of the packing ring segment 21—viewed in the direction of the circumference—, namely in the area of the radial wear gap 22, the anti-rotation groove 24 may become narrower, since said wear gap 22 is also available for the anti-rotation nib 26. As a result, the radial packing ring segment 21 is mechanically weakened less by the anti-rotation groove 24. Conversely, this means that the anti-rotation nib 26 may become wider, and thus more material thickness can be achieved for the anti-rotation nib 26.

Most advantageously, anti-rotation grooves 24 are molded at both ends of the radial packing ring segment 21, since in that case said anti-rotation grooves 24 can become even narrower, or rather the anti-rotation nib even wider, since the anti-rotation nib 26 can engage in both anti-rotation grooves 24.

At least the tangentially cut packing ring segment 20 comprising the anti-rotation nib 26 is manufactured by means of the injection molding process. Preferably, from the perspective of the manufacturing process, the radially cut packing ring segment 21 is also produced cheaply by means of the injection molding process. In this connection, the anti-rotation groove 24 is preferably molded already during injection molding, may however also be incorporated subsequently. Preferably, however, all packing ring segments 20, 21 are injection-molded with the anti-rotation nib 26 or the anti-rotation groove 24.

1. A radially cut injection-molded packing ring segment, wherein a radial anti-rotation groove (24) is molded in a front surface (25) at one end thereof.

2. The radially cut injection-molded packing ring segment in accordance with claim 1, wherein said radial anti-rotation groove (24) is molded in a front surface (25) at both ends of the packing ring segment (21).

3. The radially cut injection-molded packing ring segment in accordance with claim 1 wherein said anti-rotation groove (24) is molded up to the radially outer circumferential surface and/or up to the radially inner circumferential surface (27) of the packing ring segment (21).

4. A tangentially cut injection-molded packing ring segment, wherein an anti-rotation nib (26) is molded at a tangentially cut packing ring segment (20) that protrudes from one front surface (28) thereof.

5. A tangentially cut injection-molded packing ring segment in accordance with claim 4, wherein the anti-rotation nib (26) extends over a portion or over the entire radial height of the packing ring segment (20).

6. A packing container comprised of a radially cut (6) and a tangentially cut packing ring (7), each of which is assembled from a number of packing ring segments (20, 21), and with said radially cut (6) and said tangentially cut packing ring (7) arranged abutting one another at the front surface, wherein a radial anti-rotation groove (24) is molded at a radially cut packing ring segment (21) at one end of said packing ring segment (21) in a front surface (25) facing the tangentially cut packing ring (7), and an anti-rotation nib (26) is molded at an injection-molded tangentially cut packing ring segment (20) at a front surface (28) facing the radially cut packing ring (6), said anti-rotation nib (26) engaging in said radial anti-rotation groove (24).

7. The packing container in accordance with claim 6, wherein an anti-rotation groove (24) is provided at all radially cut packing ring segments (21).

8. The packing container in accordance with claim 7, wherein an anti-rotation nib (26) is molded at all tangentially cut packing ring segments (20).

9. The packing container in accordance with claim 6, wherein a radial anti-rotation groove (24) is molded in a front surface (25) of the radially cut packing ring (6) at the facing ends of two adjacent radially cut packing ring segments (21), and the anti-rotation nib (26) at the injection-molded tangentially cut packing ring segment (20) engages in the anti-rotation grooves (24) of the two radially cut packing ring segments (21).

10. The packing container in accordance with claim 6, wherein the anti-rotation groove (24) is molded up to the radially outer circumferential surface and/or up the radially inner circumferential surface (27) of the radially cut packing ring segment (21).

11. A pressure packing comprised of a number of packing containers arranged in series, with at least one packing container (2) embodied in accordance with claim 6.
